(19) United States
(12) Patent Application Publication
(10) Pub. No.: US 2012/0158904 A1
(43) Pub. Date: Jun. 21, 2012

(54) Method and Electronic Device for Receiving, Viewing and Forwarding Information Published on Network

(75) Inventors: Zhiqiang He, Beijing (CN); Yan Li, Beijing (CN); Xuelian Li, Beijing (CN)

(73) Assignee: Lenovo (Beijing) Co., Ltd., Beijing (CN)

(21) Appl. No.: 13/393,592

(22) PCT Filed: Aug. 27, 2010
(86) PCT No.: PCT/CN2010/076428

§ 371 Date: Mar. 1, 2012

(30) Foreign Application Priority Data
Sep. 1, 2009 (CN) 200910092142.4

(51) Int. Cl. G06F 15/16

(52) U.S. Cl. 709/217

(57) ABSTRACT

A method and electronic device for receiving, viewing, and forwarding information published on the network enables a user to view in real time information update content on a network information platform without having to log on the network information platform. The method of receiving information published on the network includes, according to a previous subscription of a second electronic device, receiving information related to content update sent by a first electronic device and when a network information platform on the first electronic device updates content; saving the information related to content update in a first part of a contact object record that is located in a contact list saved by the second electronic device, and there being saved in a second part of the contact object record contact object information of the contact object record, the network information platform corresponding to the contact object record through the contact object information.

### BACKGROUND

The present invention relates to the field of network communication technologies, and specially, refers to a method and electronic device for receiving, viewing and forwarding information published on the network.

For the past few years, thanks to the rapid development of information technology, Internet and mobile communication devices such as cellphones have become indispensable material necessities in the life of youth. Internet not only enables people to keep themselves posted to social affairs and important news, but also makes communication rapid, simple and easy. With the merits of portability, mobile communication devices such as cellphones make interpersonal communication more instant and feasible anytime and anywhere.

At present, online communication software, by which people communicate over the Internet, includes MSN, QQ and others. Besides, the development of SNS (Social Network Service) communication platforms in the Internet industry also gained momentum during recent years. The major domestic SNS platforms presently include websites of Xiaonei, Kaixin, Douban and the like.

The service network of mobile communication devices has been able to interconnect with the Internet, so that it is possible for mobile communication devices to integrate with the above-mentioned online communication software or SNS communication platforms. People can exchange information with others instantly by using the communication manners provided by online communication software or SNS communication platforms via mobile communication devices.

Under the current technical circumstances, while people communicate with others by using the aforementioned online communication software via mobile communication devices, Instant Messenger (IM) software such as MSN, QQ, and so on has to be installed on the mobile communication devices. Moreover, when people log on SNS communication platforms via mobile communication devices, update information published by a user can be viewed only when they opens browsers on the mobile communication devices so as to log onto the corresponding SNS communication platforms.

During the realization of the present invention, the inventor found the following defects existing in the prior art: the above-mentioned method for communicating with other people by using online communication software or SNS platforms via mobile communication devices requires running a program or logging on a browser on the mobile communication device. This operation is not only fussy and complicated, but also hinders the strength of instant communication of mobile communication devices. For instance, when there is a user who posts update information on the SNS platform, the newly posted information can't be fed back to a mobile communication device instantly and thus the user cannot grasp the information in the first place. Instead, this update information can be watched only when the user logs on and views it on his/her own initiative. Therefore, mobile communication devices can't be fully utilized by integrating with SNS communication platforms effectively.

### SUMMARY

An objective of the technical solution of the present invention is to provide a method and electronic device for receiving, viewing and forwarding information published on the network, to enable a user to view in real time information update content on a network information platform without having to log on the network information platform.

In order to achieve the objective mentioned above, one aspect of a particular embodiment of the present invention provides a method of receiving information published on the network, used in a second electronic device that is connected with at least one first electronic device via a network, said method comprises:

according to previous subscription of said second electronic device, receiving information related to content update sent by said first electronic device, when a network information platform on said first electronic device updates content;

saving said information related to content update in a first part of a contact object record, said contact object record being located in a contact list saved by said second electronic device, and there being saved in a second part of said contact object record contact object information of said contact object record, said network information platform corresponding to said contact object record through said contact object information.

Preferably, after receiving said information related to content update sent by said first electronic device, said method mentioned above further comprising the steps of:

acquiring first information content of said information related to content update;

comparing said first information content with a network platform subscription record, which is saved in a contact comparison table;

when it is determined that said first information content has previously been recorded in said network platform subscription record, and one network platform subscription information in said network platform subscription record is the same as said first information content, searching for and acquiring said contact object information in said contact comparison table, in which there is recorded correspondence relationship between said contact object information and said network platform subscription information.

Preferably, after the step of comparing said first information content with said network platform subscription record, said method mentioned above further comprising:

when it is determined that said first information content has not previously been recorded in said network platform subscription record, prompting a user whether or not to specify the corresponding contact object record of said network information platform;

judged whether or not an instruction for specifying said corresponding contact object record is received, and if the judgment result is yes, then according to the corresponding contact object information inputted in said instruction, searching for and obtaining said contact object record in said contact list, there being saved in the second part of said contact object record said corresponding contact object information; if the judgment result is no, then receiving and displaying said information related to content update in the form of a short message.

Preferably, in said method mentioned above, said first information content comprises platform information and/or address information of said network information platform, and said information related to content update further comprises second information content, which includes specific content of the update and/or link address of the update content.

Preferably, after the step of saving said information related to content update in said first part, said method mentioned above further comprising:

displaying said contact object record in said contact list distinctively, to prompt said user that said information related to content update has been saved in said contact object record.

Preferably, in said method mentioned above, before receiving said information related to content update, said second electronic device previously subscribes to said information related to content update when said network information platform updates content, wherein the step of said second electronic device previously subscribing to said information related to content update particularly comprises:

registering a subscription service to said first electronic device, saving identity authentication information of said second electronic device as well as saving a network platform subscription record that corresponds to said second electronic device in a subscription address list of said first electronic device.

Preferably, in said method mentioned above, said second electronic device is a mobile terminal, and before receiving said information related to content update, said mobile terminal previously subscribes to said information related to content update when said network information platform updates content, wherein the step of said mobile terminal previously subscribing to said information related to content update particularly comprises:

registering subscription service information to a mobile communication server, said subscription service information including a mobile communication number of said mobile terminal and a network platform subscription record that corresponds to said mobile terminal, storing said subscription service information in a subscription list by said mobile communication server, and there being established a network interface connection previously between said mobile communication server and said first electronic device.

Preferably, in said method mentioned above, before receiving said information related to content update sent by said first electronic device, further comprising:

acquiring content update status of said network information platform from a third electronic device, wherein said third electronic device previously stores a network platform subscription record of said second electronic device, and inquires said first electronic device for said content update status at an interval of a preset time;

according to said content update status, sending a retrieving request for the content update of said network information platform to said first electronic device.

Preferably, in said method mentioned above, before receiving said information related to content update sent by said first electronic device, further comprising:

acquiring content update status of said network information platform from a third electronic device, wherein said third electronic device previously stores a network platform subscription record of said second electronic device, and inquires said first electronic device for said content update status at an interval of a preset time;

according to said content update status, sending a retrieving request for the content update of said network information platform to said third electronic device;

receiving said information related to content update from said third electronic device, wherein said third electronic device, according to said content update status, previously acquires said information related to content update from said first electronic device and saves it.

Preferably, in said method mentioned above, before receiving said information related to content update sent by said first electronic device, further comprising:

acquiring content update status of said network information platform from a third electronic device, said third electronic device previously storing a network platform subscription record of said second electronic device and inquiring said first electronic device for said content update status at an interval of a preset time;

receiving said information related to content update from said third electronic device, wherein said third electronic device, according to said content update status, previously acquires said information related to content update from said first electronic device and saves it.

Another aspect of the present invention further provides an electronic device for forwarding information published on the network, said electronic device is used to forward information related to content update published by a network information platform on a first electronic device to a second electronic device in order to display, said electronic device comprises:

a storing unit, which is used to store a network platform subscription record of said second electronic device, said network platform subscription record saving address information and/or address information of at least one network information platform to which said second electronic device previously subscribes, and said network information platform being located on said first electronic device;

a update status inquiring unit, which is used to inquire said first electronic device for content update status of said network information platform at an interval of a preset time, according to said network platform subscription record;

a update status sending unit, which is used to send said content update status to said second electronic device.

Another aspect of the present invention further provides a method of viewing information published on the network, used in a second electronic device that is connected with at least one first electronic device via a network, said second electronic device comprises a displaying unit and a contact list which includes at least one contact object record, and said contact object record each includes a first part and a second part, said first part being used to record network content information that comes from a network information platform on said first electronic device, and said second part being used to record contact object information, said network information platform corresponding to said contact object record through said contact object information, said method comprising:

receiving a first operation instruction from a user of said second electronic device, and said first operation instruction being used to instruct said second electronic device to display said contact list;

based on said first operation instruction, displaying said contact list on said displaying unit;

receiving a second operation instruction from the user of said second electronic device, and said second operation instruction being used to select and open a first contact object record from said at least one contact object record;

based on said second operation instruction, selecting and opening said first contact object record;

displaying the first part and second part of said first contact object record on said displaying unit.

Furthermore, still another aspect of the present invention further provides an electronic device for viewing information published on the network, connected with at least one network platform server via a network, said electronic device comprising:

a information receiving unit, which is used to receive information related to content update which is sent according to previous subscription of said electronic device when a network information platform on said network platform server updates content;

a storing unit, which is used to store a contact list that includes at least one contact object record, a first part of said contact object record being used to store said information related to content update, and a second part of said contact object record being used to save contact object information of said contact object record, said network information platform corresponding to said contact object record through said contact object information;

a displaying unit, which is used to display said first part and said second part in a first area and a second area respectively.

Preferably, in said electronic device mentioned above, said storing unit is further used to store a contact comparison table, which is used to save correspondence relationship between said network information platform and said contact object information.

At least one of the technical solutions mentioned above has the following beneficial effects:

by adopting the method and electronic device for receiving, viewing and forwarding information published on the network mentioned in the particular embodiment of the present invention, when a network information platform makes content update, information related to content update can be sent to and saved in a mobile terminal according to previous subscription. In this way, when viewing the information related to content update of this network information platform on the mobile terminal, it is only needed to open the contact object record in the contact list saved in the mobile terminal, without the need to log on the relevant network information platform. Moreover, the developments of the information update of the network information platform can be grasped in the first place anytime and anywhere, therefore the procedure can bring great convenience to the user during its usage;

different strategies can be set for the promotion that different contact object records receives the information related to content update. For example, the contact object record can be updated directly for the contact object record that frequently receives the information related to content update, without setting any reception promotion. It is only needed to display this contact object record distinctively in order to promote the user when the user views the contact list, so that the interference to the user due to the reception of the promotion can be reduced, and the normal usage of the electrical device by the user can be avoided from being affected by frequent sending of the information related to content update.

### BRIEF DESCRIPTION OF THE DRAWINGS

FIG. 1 is the schematic structure diagram of an electronic device that can receive and view information published on the network, which is mentioned in a particular embodiment of the present invention;

FIG. 2 is the schematic flow diagram that illustrates a method of an electronic device receiving information related to content update from a network information platform, which is mentioned in the first embodiment of the present invention;

FIG. 3 is the schematic flow diagram that illustrates a method of an electronic device receiving information related to content update from a network information platform, which is mentioned in the second embodiment of the present invention;

FIG. 4 is the schematic flow diagram that illustrates information published on the network being sent to and received by an electronic device mentioned in the present invention;

FIG. 5 is the schematic structure diagram of an electronic device that forwards information published on the network, which is mentioned in a particular embodiment of the present invention; and

FIG. 6 is the schematic flow diagram that illustrates a method of viewing information published on the network, which is mentioned in a particular embodiment of the present invention.

### DETAILED DESCRIPTION

In order to make the purpose, technical solution and advantage thereof clearer, the present invention is described in detail below in connection with the drawings and the particular embodiments.

By making use of the feature that two electronic devices can be interconnected via a network in the prior art, the method and electronic device for receiving, viewing and forwarding information published on the network mentioned in the particular embodiment of the present invention enable a first electronic device, when a network information platform on the first electronic device performs content update, to send information related to content update to a second electronic device that is connected with the first electronic device via the network to display, according to the previous subscription of the second electronic device. Moreover, the second electronic device saves the information related to content update of the network information platform in one of contact object records of a local contact list. In this way, when viewing the information related to content update of this network information platform on the local second electronic device, it is only needed to open this one of contact object records in this contact list instead of logging on this network information platform, which is convenient for a user to find out the latest developments on this network information platform in real time.

The method for receiving information published on the network and the method for viewing information published on the network as well as the electronic device mentioned in the particular embodiment of the present invention will be described in detail below.

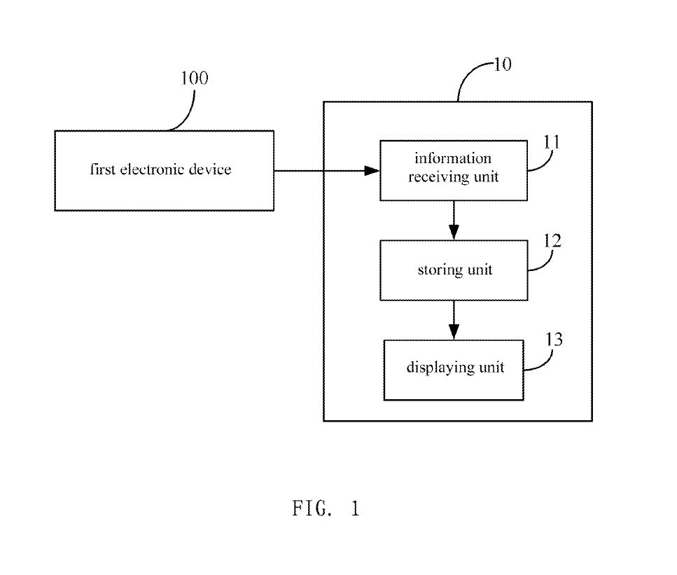

FIG. 1 is the schematic structure diagram of an electronic device that can receive and view information published on the network, which is mentioned in a particular embodiment of the present invention. Referring to FIG. 1, in the particular embodiment of the present invention, a first electronic device 100 is a network server of a network information platform, and a second electronic device 10 is connected with the first electronic device 100 via a network. This second electronic device 10 is used to receive and view the information published on the network from the first electronic device 100. Wherein, the second electronic device 10 includes:

a information receiving unit 11, which is used to receive information related to content update sent to the second electronic device 10 by the first electronic device 100 when a network information platform on the first electronic device 100 performs the content update. The second electronic device 10 has previously subscribed to the information related to content update of this network information platform. Wherein, this network information platform can be either a news information platform or a certain registered user's information releasing platform in a SNS communication community or other similar platforms. This SNS community includes communities like blogs, online albums, websites of Xiaonei and Kaixin, MSN, QQ or the like, that is to say, all network information platforms that allow an object with a unique identity to publish information.

Specifically, the user who uses the second electronic device 10 can subscribe to a certain registered user's update information on one SNS communication platform, or the user can also subscribe to all update information published by this registered user on the aforementioned several SNS communication platforms at the same time, or else subscribe to update information published in real time by a certain kind of news community on a news information platform such as a sport community, an entertainment community and so on.

Those skilled in the art can understand that different information publishing platforms, such as blogs, online albums, websites of Xiaonei and Kaixin, MSN, QQ or the like, belong to different network servers. The second electronic device 10 can simultaneously subscribe to content update information of multiple network information platforms mentioned above, therefore the first electronic device 100 to which these network information platforms belong can be a server group.

The second electronic device 10 also includes: a storing unit 12, which is used to store a contact list that includes at least one contact object record. Each contact object record includes two parts. The first part is used to save the information related to content update obtained from the information receiving unit 11, while the second part is used to save the contact object information of the contact object corresponding to the relevant contact object record. The first part of each contact object record correspondingly receives the information related to content update on at least one network information platform, that is to say, each contact object record corresponds to at least one network information platform by means of the relevant contact object information.

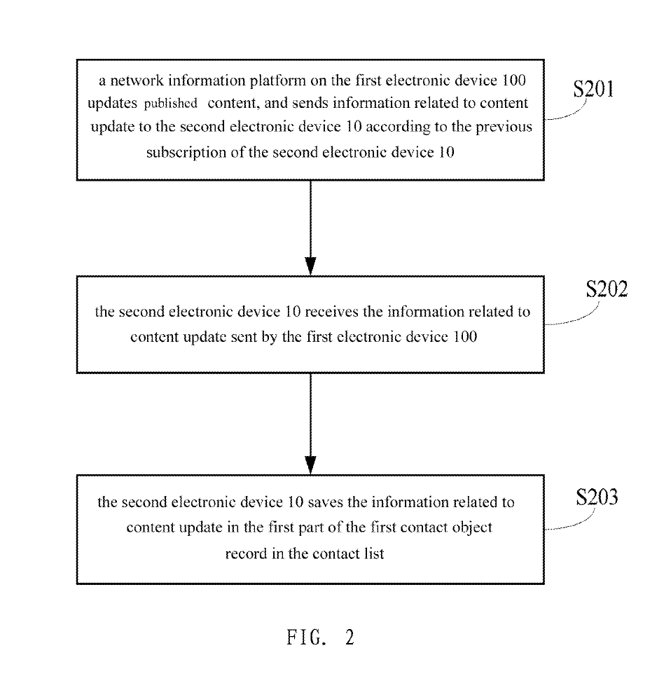

The second electronic device 10 also includes: a displaying unit 13, which is used to display the first part and second part of the corresponding contact object record in a first area and a second area respectively. As shown, FIG. 2 is the schematic flow diagram that illustrates a method of the second electronic device 10 receiving information related to content update from a network information platform on the first device 100, which is mentioned in the first embodiment of the present invention. Referring to FIG. 2, this method includes following steps:

S201, a network information platform on the first electronic device 100 updates published content, and sends information related to content update to the second electronic device 10 according to the previous subscription of the second electronic device 10;

S202, the second electronic device 10 receives the information related to content update sent by the first electronic device 100;

S203, the second electronic device 10 saves the information related to content update in the first part of the first contact object record in the contact list. In the second part of the first contact object record, there is saved the contact object information of the contact object corresponding to this contact object record. This first contact object record corresponds to the network information platform by means of the contact object information.

For example, according to one particular embodiment of the present invention, based on the contact list saved by the second electronic device 10, the information related to content update can be saved in the first part of the first contact object record of the contact list.

In the particular embodiment of the present invention, said information related to content update sent to the second electronic device 10 by the first electronic device 100 includes two parts of information content. Wherein, the first information content in the two parts of information content includes the user information, address information and/or updating time of the platform that publishes the information related to content update, so that the second electronic device 10, after receiving the information related to content update, can know which network information platform publishes this information, the information publishing time, and etc. The second information content in the two parts of information content includes the specific content and/or the link address of update content of the update that is made. When the second information content is the specific content of the update, the user can visually see on the second electronic device 10 the update content published on the network information platform. When the second information content is the link address of the update content, the second information content further links to the network communication interface of the second electronic device 10. The user can click the link address of the content update on the second electronic device, which causes the second electronic device 10 to log onto the network information platform that publishes the update content, and then the user can see the information related to content update of the network information platform.

Preferably, the storing unit 12 of said second electronic device 10 stores a contact comparison table, which includes at least one contact object information and at least one network platform subscription record, and saves the correspondence relationship between each network information platform and the corresponding contact object information. Wherein, each contact object information respectively corresponds to the content of the second part recorded by one of contact objects in the contact list. Each network platform subscription information in the network platform subscription record includes platform user information and/or address information, and each contact object information correspondingly associates with at least one network platform subscription information. In this way, when a network information platform sends the information related to content update to the second electronic device 10 and the address information and/or platform information of the network information platform corresponds to one of network platform subscription information within the contact comparison table, the contact object information related to network information platform can be found by means of the contact comparison table, so that the information related to content update of the network information platform can be sent to the corresponding contact object record in the contact list.

Additionally, when a network information platform sends the information related to content update to said second electronic device 10, but the contact comparison table saved by the storing unit 12 of the second electronic device 10 doesn't save the platform information of the network information platform, and the user hopes that the network information platform establishes association with one of contact object records in the contact list, the contact information of the contact object record with which the association is meant to be established can be manually specified or inputted in the contact comparison table, so that the correspondence relationship is established between the contact object record and the network information platform. Thereafter, the information related to content update send by the network information platform will all be saved in the first part of the contact object record in the contact list according to the correspondence relationship.

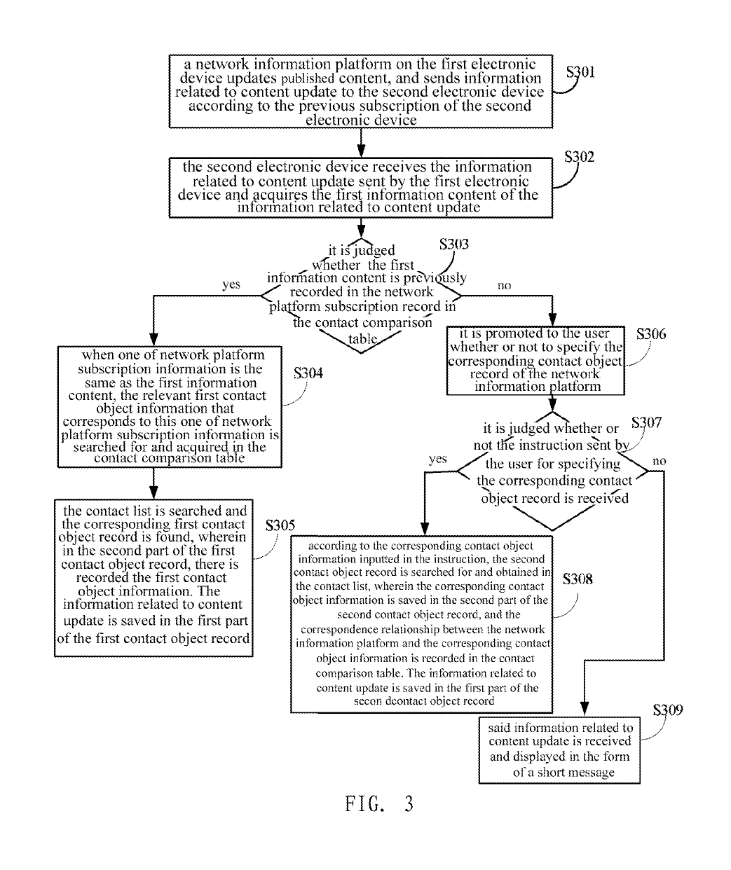

FIG. 3 is the schematic flow diagram that illustrates a method of the second electronic device 10 receiving information related to content update from a network information platform on the first electronic device 100, which is mentioned in the second embodiment of the present invention. Referring to FIG. 3, the method includes:

Step S301, a network information platform on the first electronic device 100 updates published content, and sends information related to content update to the second electronic device 10 according to the previous subscription of the second electronic device 10;

Step S302, the second electronic device 10 receives the information related to content update sent by the first electronic device 100 and acquires the first information content of the information related to content update;

Step S303, said first information content is compared with the network platform subscription record saved in the contact comparison table, and it is judged whether the first information content is previously recorded in the network platform subscription record in the contact comparison table. If the judgment result is yes, then go on to perform Step S304 and if the judgment result is no, then go on to perform Step S306;

Step S304, when it is determined that one of network platform subscription information in said network platform subscription record is the same as said first information content, the relevant first contact object information that corresponds to said one of network platform subscription information is searched for and acquired in the contact comparison table, and go on to perform Step S305;

Step S305, the contact list is searched and the corresponding first contact object record is found, wherein in the second part of the first contact object record, there is recorded the first contact object information. Said information related to content update is saved in the first part of the first contact object record;

Step S306, it is promoted to the user whether or not to specify the corresponding contact object record of said network information platform;

Step S307, it is judged whether or not the instruction sent by the user for specifying said corresponding contact object record is received. If the judgment result is yes, then go on to perform Step S308. If the judgment result is no, then go on to perform Step S309;

Step S308, according to the corresponding contact object information inputted in said instruction, the second contact object record is searched for and obtained in said contact list. The corresponding contact object information is saved in the second part of said second contact object record, and the correspondence relationship between the network information platform and the corresponding contact object information is recorded in the contact comparison table. Said information related to content update is saved in the first part of the second contact object record;

Step S309, said information related to content update is received and displayed in the form of a short message.

In addition to the above-mentioned embodiments, the present invention can also disregard whether there is corresponding contact object record in the contact list, and directly receive and display said information related to content update in the form of a short message.

As shown, Table 1 and Table 2 are respectively an embodiment that said storing unit 12 stores the contact list and the contact comparison table in the particular embodiment of the present invention.

TABLE 1

| Contact Object Record | Second Part | First Part |
|---|---|---|
| 1 | Ming Li | Omitted |
| 2 | Jia Wang | Omitted |
| 3 | Elder Sister | Omitted |
| 4 | Baidu News | Omitted |

TABLE 2

| | Contact Object | |
|---|---|---|
| | Information | Network platform Subscription Record |
| 1 | Ming Li | http://liming.bloq.sohu.com |
| 2 | Elder Sister | http://zhangyu.xiaonie.com |
| 3 | Jia Wang | http://wangjia.blog.sohu.com |
| | | http://11111.qzone.com.cn |
| 4 | Baidu News | http://news.baidu.com/ |

For instance, using the contact list of Table 1 and the contact comparison table of Table 2 stored in the storing unit 12 mentioned above, in order to enable the user to grasp in real time the latest developments of the information published by a friend Ming Li in the SNS community such as blog, the user can subscribe to the update information of the registered user on the blog via the second electronic device 10 having the above mentioned structure. When this friend Ming Li updates published content on the blog address (http://liming.blog.sohu.com), the network server 100 in which this blog locates sends information related to content update which contains the blog address and is related to updated content to the second electronic device 10 according to the subscription of the second electronic device 10. By comparing the first information content of the information related to content update, which is the blog address, with the contact object information in Table 2, the second electronic device 10 determines that the contact object information which corresponds to the blog address is “Ming Li”, finds the contact object record whose contact information is “Ming Li” in the contact list, according to the correspondence relationship between the contact object information in Table 2 and the contact object record saved in Table 1, and saves the information related to content update in the first part of the contact object record.

Based on the above, in Table 2, there is recorded the blog address and QQ Zone address whose contact object is “Jia Wang”. Therefore, when the contact object makes content update on whether his/her blog or QQ Zone, the information related to content update will both be sent to the contact object record whose contact information is “Jia Wang” in the second electronic device 10, that is to say, the information related to content update of the contact object on the blog and QQ Zone will both be saved in the first part of this contact object record in the contact list.

Those skilled in the art can understand that the contact object information recorded in Table 1 and Table 2 is not limited to being the same as the user name that is registered on the network information platform by the contact user. As shown in the contact comparison table in Table 2, the address of contact user “Yu Zhang” in the website of Xiaonei is http://zhangyu.xiaonie.com, while the contact object information record that corresponds to this address in the Xiaonei Website is “Elder Sister”, instead of the registered user name “Yu Zhang” of the contact user. Table 1 and Table 2 can be associated with each other as long as it is also recorded in the relevant contact object record in the contact list that the contact information is “Elder Sister”. The related information when the content update is made in the address in Xiaonei Website is sent to the contact object record whose contact information is “Elder Sister” in the contact list in order to be saved, so that connection is established between the contact object record and the user in the Xiaonei Website.

In the particular embodiment of the present invention, preferably, after one of contact object records in the contact list of the second electronic device 10 receives the information related to content update sent by the network information platform, it can be promoted that the contact object record has saved the related information to content update by means of sound and/or twinkling displaying, or the contact object record can be displayed with a special (distinctive) display effect such as highlighting or using a different color in the contact list in order to alert the user, or else the contact object record that newly receives the information related to content update is displayed differently only when the user views the contact list without any promotion. In addition, in order to avoid interruption of the user's normal use of the electronic device due to frequently sending the information related to content update when the subscribed network information platform is in active status, a promotion strategy after the second electronic device 10 receives the information related to content update can be set. For example, one of contact object records recorded in the contact list is set with a sound to promote the receiving of the information related to content update during a first set time like 8 o'clock to 20 o'clock, and is set without any promotion during a second set time like 20 o'clock to 8 o'clock in the next morning. There can be various similar setting manners, which will not be elaborated one-by-one herein, wherein different promotion strategies can be set for different contact object records.

The step of said second electronic device 10 previously subscribing to said information related to content update can include: a subscription service is registered to said first electronic device 100, identity authentication information of said second electronic device 10 as well as the network platform subscription record that corresponds to said second electronic device 10 are saved in the subscription address list of said first electronic device 100.

The second electronic device 10 mentioned in the particular embodiment of the present invention can be a computer device or a mobile terminal.

When the second electronic device 10 is a computer device, the following manners can be adopted to previously subscribe to the information related to content update from a network information platform:

establishing a subscription list on the network server (the first electronic device 100) of the network information platform, and saving all the IP addresses of the computers that subscribe to the information related to content update of this network information platform through this subscription list;

writing the IP address of the second electronic device 10 into the subscription list.

In this way, when there is content update made on the network information platform, the first electronic device 100 can determine which computer devices subscribe to the information related to content update of this network information platform by reviewing the subscription list, thereby send the information related to content update to the corresponding computer device. Those skilled in the art should be able to understand this subscription manner, which is not described in detail herein.

Said second electronic device 10 is a mobile terminal. When the second electronic device 10 previously subscribes to the information related to content update to a network information platform, the above-mentioned manner of registration on the network server of the network information platform can be adopted: establishing a subscription list on the first electronic device 100, writing the mobile terminal communication number of the second electronic device 10 and the address information of the subscribed network information platform into the subscription list, making the network server send the information related to content update when the network information platform makes content update to the mobile terminal, according to this subscription list and using the communication interface between the network server and the mobile communication server.

Additionally, the second electronic device 10 can also previously subscribe to the information related to content update from a network information platform by adopting the manner of registration on the mobile communication server, particularly including:

there being established a network interface connection previously between the mobile communication server of the second electronic device 10 and the network server, so that the network connectivity between the mobile terminal and the computer device is realized;

the mobile communication server establishing a subscription list previously;

the second electronic device 10 registering subscription service information to the mobile communication server, and writing the subscription service information into the subscription list, so as to subscribe to the information related to content update when at least one network information platform makes content update. The subscription service information includes the address information of the subscribed network information platform and the mobile communication number of the second electronic device 10.

By subscribing to the information related to content update of a network information platform from the mobile communication server as mentioned above, the mobile communication server, when receiving this information related to content update of the network information platform, can determine which mobile terminals have previously subscribed to the information related to content update of the network information platform by reviewing the subscription list, so as to send the information related to content update to the corresponding mobile terminal.

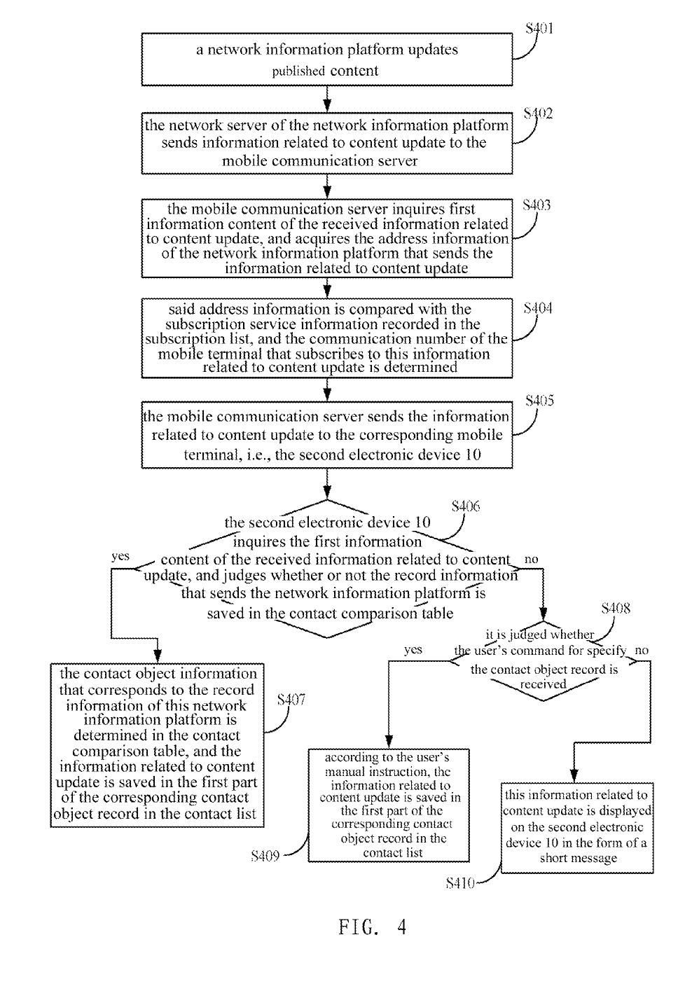

The procedure of network publishing information being sent to said electronic device of the present invention and being received is illustrated below by adopting the manner of previous subscription of the mobile communication server. Referring to FIG. 4, the procedure includes the steps:

S401, a network information platform updates published content;

S402, the network server of the network information platform sends information related to content update to the mobile communication server;

S403, the mobile communication server inquires first information content of the received information related to content update, and acquires the address information of the network information platform that sends the information related to content update;

S404, said address information is compared with the subscription service information recorded in the subscription list, and the communication number of the mobile terminal that subscribes to this information related to content update is determined;

S405, the mobile communication server sends the information related to content update to the corresponding mobile terminal, i.e., the second electronic device 10;

S406, the second electronic device 10 inquires the first information content of the received information related to content update, compares the first information content with the network platform record information in the contact comparison table of the storing unit one by one, and judges whether or not the record information that sends the network information platform is saved in the contact comparison table. If the judgment result is yes, then go on to perform step S407. If the judgment result is no, then go on to perform step S408;

Step S407, the contact object information that corresponds to the record information of this network information platform is determined in the contact comparison table, and the received information related to content update is saved in the first part of the corresponding contact object record in the contact list;

Step S408, it is judged whether the user's command for specify the contact object record is received. If the judgment result is yes, then go on to step S409. If the judgment result is no, then go on to perform step S410;

Step S409, according to the user's manual instruction, the information related to content update is saved in the first part of the corresponding contact object record in the contact list;

Step S410, this information related to content update is displayed on the second electronic device 10 in the form of a short message.

Through the above-mentioned procedure, when a network information platform makes content update, information related to content update can be sent to and saved in a mobile terminal according to previous subscription. In this way, when viewing the information related to content update of this network information platform on the mobile terminal, it is only needed to open the relevant contact object record in the contact list saved in the mobile terminal. Even in the case that there is no relevant contact object record in the contact list, the information related to content update can be displayed on the second electronic device 10 in the form of a short message, without the need to log on the network information platform. Moreover, the developments of the information update of the network information platform can be grasped in the first place anytime and anywhere, therefore the procedure can bring great convenience to the user during its usage.

In the particular embodiment of the present invention, when the second electronic device 10 can be a computer device or a mobile terminal, in addition to the subscription manner introduced above, said second electronic device 10 can also previously subscribe to the information related to content update from a network information platform through a third electronic device. Specifically, the following method can be adopted:

the third electronic device receiving the subscription of the second electronic device 10, establishing the subscription list used to save the IP addresses of the second electronic device 10 and the network platform subscription record of the second electronic device 10. The network platform subscription record saves the address information and/or the address information of at least one network information platform to which the second electronic device 10 previously subscribes, so that the third electronic device, according to the recorded subscription list, can obtain from the first electronic device 100 the information related to content update issued when the relevant network information platform makes content update, and then send it to the second electronic device 10.

Furthermore, in the particular embodiment of the present invention, the third electronic device, according to the recorded subscription list, can also on its own initiative inquire the first electronic device 100 for the content update status of the network information platform at an interval of a preset time, and send the content update status of the network information platform to the second electronic device 10 when this network information platform makes content update.

Therefore, in the particular embodiment of the present invention, according to the content update status sent by the third electronic device, said second electronic device 10 can initiatively send to the first electronic device 100 a retrieving request for the content update of the network information platform, and obtain the information related to content update of said network information platform from the first electronic device 100.

Another manner for said second electronic device 10 to obtain the information related to content update of said network information platform from said first electronic device 100 can be as follows: when obtaining the content update status of said network information platform, said third electronic device initiatively retrieves the information related to content update of this network information platform from the first electronic device 100, and then saves and sends the information related to content update to the second electronic device 10 timely and initiatively, which enables the second electronic device 10 to obtain this information related to content update from the third electronic device.

Furthermore, yet another manner for said second electronic device 10 to obtain the information related to content update of said network information platform from said first electronic device 100 can also be as follows: when obtaining the content update status of said network information platform, said third electronic device initiatively retrieves the information related to content update of this network information platform from the first electronic device 100 and saves it; according to said content update status, the second electronic device 10 sends to the third electronic device a retrieving request for the content update of said network information platform; after receiving the retrieving request for the content update, the third electronic device sends the information related to content update which is previously acquired from the first electronic device 100 and saved to the second electronic device 10.

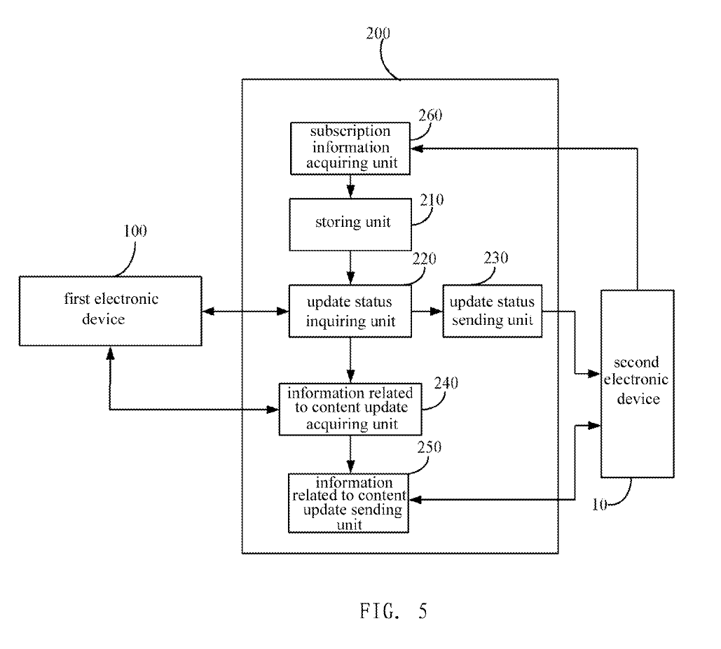

Therefore, another aspect of the particular embodiment of the present invention also provides a third electronic device mentioned above, which is used to forward the network publishing information of the network information platform on the first electronic device 100 to the second electronic device 10 according to the subscription of the second electronic device 10. FIG. 5 is the schematic structure diagram of a third electronic device 200. The third electronic device 200 is used to send content update information published on a network information platform on the first electronic device 100 to the second electronic device 10 to display. Referring to FIG. 5, the third electronic device 200 includes:

a storing unit 210, which is used to store the network platform subscription record of the second electronic device 10. The network platform subscription record saves the address information and/or the address information of at least one network information platform to which the second electronic device 10 previously subscribes. The network information platform is located on the first electronic device 100;

a update status inquiring unit 220, which is used to inquire the first electronic device 100 for the content update status of said network information platform at an interval of a preset time, according to said network platform subscription record;

a update status sending unit 230, which is used to send said content update status to the second electronic device 10.

Preferably, the third electronic device 200 can also include:

a information related to content update acquiring unit 240, which is used to acquire the information related to content update of the network information platform on the first electronic device 100;

a information related to content update sending unit 250, which is used to initiatively send said information related to content update to the second electronic device 10, or send the information related to content update to the second electronic device 10 according to the request of the second electronic device 10;

a subscription information acquiring unit 260, which is used to acquire the network platform subscription information that is registered or sent to the third electronic device 200 by said second electronic device 10. There is included in the network platform subscription information the address information and/or platform information of the network information platform that is subscribed to by the second electronic device 10; additionally, the subscription information acquiring unit 260 is also used to save the network platform subscription information in said storing unit 210, that is, to save the network platform subscription information in the network platform subscription record of the storing unit 210, wherein the network platform subscription record corresponds to this second electronic device 10.

In this way, according to this network platform subscription record, the third electronic device 200 can acquire the content update status and the information related to content update of the relevant network information platform from the first electronic device 100, and forward them to the second electronic device 10.

Among the first electronic device 100, the second electronic device 10 and the third electronic device 200 mentioned above, the first electronic device 100 can be a server used to provide the information published on the network, the second electronic device 10 can be a computer or mobile terminal used to receive the information published on the network, and the third electronic device 200 can be a server used to forward the information published on the network to the computer or mobile terminal.

Those skilled in the art can understand that said third electronic device 200 can be a server group constituted of multiple servers. With the combination of multiple servers, the servers cooperates to complete the subscription procedure of the second electronic device 10, and the procedure of forwarding the information published on the network of the network information platform on the first electronic device 100 to the second electronic device 10.

The third electronic device 200 with the above-mentioned structure can be used specifically to provide the forwarding of the information published on the network, and to provide information related to network update of multiple network information platforms for each electronic device among multiple second electronic devices 10, so as to enhance the processing efficiency of the forwarding and receiving of network information. Another aspect of the particular embodiment of the present invention also provides a method for viewing the information published on the network, which is used on the second electronic device that is connected with at least one first electronic device via the network. Referring to FIG. 1, the second electronic device 10 includes a displaying unit and a contact list which includes at least one contact object record, and each contact object record includes the first part used to record the network content information and the second part used to record the contact object information. The first information content of said network content information is associated with at least a part of said contact information, and the network content information comes from the first electronic device 100 connected with the second electronic device 10 via the network. The second electronic device 10 has previously subscribed to the network content information from a network information platform, which corresponds to said contact object record through said contact object information. Wherein the manner of the second electronic device 10 subscribing to the network content information from a network information platform is as mentioned above, which is not described in detail herein.

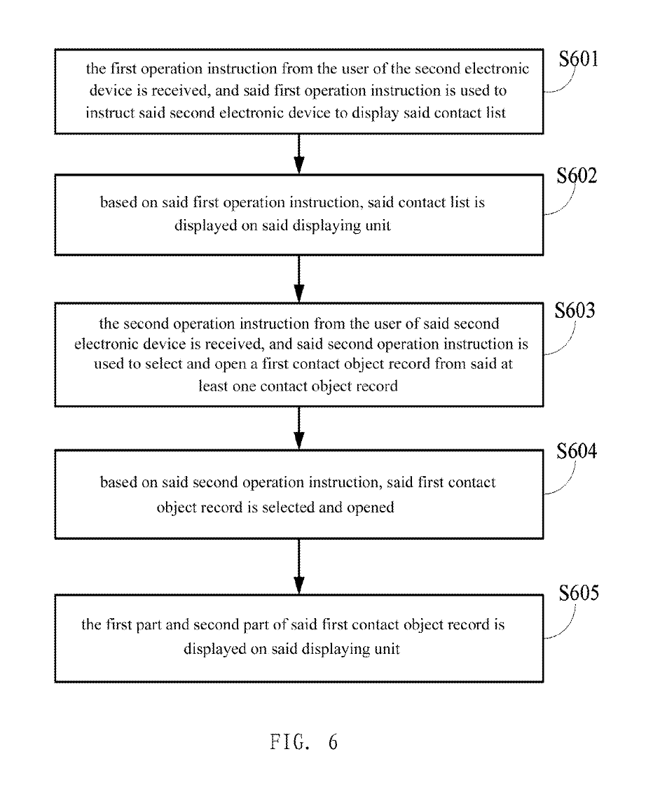

Referring to FIG. 6, the method of viewing information published on the network mentioned in the particular embodiment of the present invention includes:

Step S601, the first operation instruction from the user of the second electronic device is received, and said first operation instruction is used to instruct said second electronic device to display said contact list;

Step S602, based on said first operation instruction, said contact list is displayed on said displaying unit;

Step S603, the second operation instruction from the user of said second electronic device is received, and said second operation instruction is used to select and open a first contact object record from said at least one contact object record;

Step S604, based on said second operation instruction, said first contact object record is selected and opened;

Step S605, the first part and second part of said first contact object record is displayed on said displaying unit.

In the method of viewing the information published on the network mentioned in the particular embodiment of the present invention, said contact list can either be the record book that is specifically used to save the network update information, or be the phone book, calling record (including missed call record, received call record or dialed call record) and the inbox of message/mail, etc. which already exists in the second electronic device. That is to say, the contact user information recorded in any one of the phone book, calling record and message inbox can be linked to display the information related to content update of the network information platform that corresponds to this contact object information.

For example, the contact list can be a phone book, and the step for the user to view the information published on the network in the phone book include: opening the phone book by the second electronic device according to the instruction for opening the phone book instructed by the user, and displaying on the display screen multiple contact object information recorded in this phone book at this time; when the user chooses one of the contact object information, displaying the contact object information, phone book information and the received information published on the network by the second electronic device on the display screen according to the user's instruction.

The contact list can also be a mail inbox, and the step for the user to view the information published on the network in the mail inbox include: opening the mail inbox by the second electronic device according to the instruction for opening the mail inbox instructed by the user, and displaying on the display screen multiple received mails recorded in the mail inbox at this time. In the subject of each received mail, there is recorded the sender's information, the subject of the mail and the sending time of the mail, etc. When the sender's information of one of the received mails is previously recorded in the contact comparison table stored in the second electronic device, a network information promotion option is also included in the subject of this received email. When the user chooses the network information promotion option, the second electronic device, according to the user's instruction, displays the information published on the network that corresponds to the receiver's information on the display screen, wherein the second electronic device has already previously subscribed to the information published on the network from the network information platform that publishes this information published on the network; moreover, when the user views the received emails in the normal manner, the second electronic device, according to the user's instruction, displays the sender's information, the received email information, etc. that is recorded in the received email on the display screen.

Furthermore, in the method of viewing the information published on the network, the information published on the network can be from either a news information platform or a certain registered user's information publishing platform in a SNS communication community. This SNS community includes communities such as blogs, online albums, websites of Xiaonei and Kaixin, MSN, QQ or the like. More specifically, the user who uses the second electronic device 10 can subscribe to a certain registered user's update information on one SNS communication platform, or the user can also subscribe to all update information published by this registered user on the aforementioned several SNS communication platforms at the same time, or else subscribe to update information published in real time by a certain kind of news community on a news information platform such as a sport community, an entertainment community and so on.

Said information related to content update includes the first information content and the second information content. The first information content includes the platform information and/or address information of said network information platform, while the second information content includes the specific content of the update and/or the link address of the update content. When the second information content is the specific content of the update, the user can visually see on the second electronic device 10 the update content published on the network information platform. When the second information content is the link address of the update content, the user can click the link address of the content update on the second electronic device, which causes the second electronic device 10 to log onto the network information platform that publishes the update content, and then the user can see the information related to content update of the network information platform.

The second electronic device mentioned in the particular embodiment of the present invention can be a computer device or a mobile terminal. By using said second electronic device to receive the information published on the network and view the information published on the network, the user is enabled to view in real time the information update content on a network information platform without having to log on the network information platform.

However, those skilled in the art can understand that the first electronic device, the second electronic device and the third electronic device mentioned in the particular embodiment of the present invention are not limited to those specific electronic devices mentioned in the particular embodiment of the present invention, but include various physical devices or logical devices, which are currently existing and have relevant abilities or which may emerge in the future and have similar abilities, or else the combination thereof.

The above mentioned is just the preferred embodiment of the present invention. It should be pointed out that, for those having ordinary skills in this technical field, on the condition of not deviating from the principle of the present invention, several improvements and refinements can be made as well, which should be also treated as the scope protected by the present invention.

1. A method of receiving information published on the network, used in a second electronic device that is connected with at least one first electronic device via a network, characterized in that, said method comprises:
according to previous subscription of said second electronic device, receiving information related to content update sent by said first electronic device, when a network information platform on said first electronic device updates content;
saving said information related to content update in a first part of a contact object record, said contact object record being located in a contact list saved by said second electronic device, and there being saved in a second part of said contact object record contact object information of said contact object record, said network information platform corresponding to said contact object record through said contact object information.

2. The method of claim 1, characterized in that, after receiving said information related to content update sent by said first electronic device, further comprising the steps of:
acquiring first information content of said information related to content update;
comparing said first information content with a network platform subscription record, which is saved in a contact comparison table;
when it is determined that said first information content has previously been recorded in said network platform subscription record, and one network platform subscription information in said network platform subscription record is the same as said first information content, searching for and acquiring said contact object information in said contact comparison table, in which there is recorded correspondence relationship between said contact object information and said network platform subscription information.

3. The method of claim 2, characterized in that, after the step of comparing said first information content with said network platform subscription record, further comprising:
when it is determined that said first information content has not previously been recorded in said network platform subscription record, prompting a user whether or not to specify the corresponding contact object record of said network information platform;
judged whether or not an instruction for specifying said corresponding contact object record is received, and if the judgment result is yes, then according to the corresponding contact object information inputted in said instruction, searching for and obtaining said contact object record in said contact list, there being saved in the second part of said contact object record said corresponding contact object information; if the judgment result is no, then receiving and displaying said information related to content update in the form of a short message.

4. The method of claim 1, characterized in that, said first information content comprises platform information and/or address information of said network information platform, and said information related to content update further comprises second information content, which includes specific content of the update and/or link address of the update content.

5. The method of claim 1, characterized in that, after the step of saving said information related to content update in said first part, further comprising:
displaying said contact object record in said contact list distinctively, to prompt said user that said information related to content update has been saved in said contact object record.

6. The method of claim 1, characterized in that, before receiving said information related to content update, said second electronic device previously subscribes to said information related to content update when said network information platform updates content, wherein the step of said second electronic device previously subscribing to said information related to content update particularly comprises:
registering a subscription service to said first electronic device, saving identity authentication information of said second electronic device as well as saving a network platform subscription record that corresponds to said second electronic device in a subscription address list of said first electronic device.

7. The method of claim 1, characterized in that, said second electronic device is a mobile terminal, and before receiving said information related to content update, said mobile terminal previously subscribes to said information related to content update when said network information platform updates content, wherein the step of said mobile terminal previously subscribing to said information related to content update particularly comprises:
registering subscription service information to a mobile communication server, said subscription service information including a mobile communication number of said mobile terminal and a network platform subscription record that corresponds to said mobile terminal, storing said subscription service information in a subscription list by said mobile communication server, and there being established a network interface connection previously between said mobile communication server and said first electronic device.

8. The method of claim 1, characterized in that, before receiving said information related to content update sent by said first electronic device, further comprising:
acquiring content update status of said network information platform from a third electronic device, wherein said third electronic device previously stores a network platform subscription record of said second electronic device, and inquires said first electronic device for said content update status at an interval of a preset time;
according to said content update status, sending a retrieving request for the content update of said network information platform to said first electronic device.

9. The method of claim 1, characterized in that, before receiving said information related to content update sent by said first electronic device, further comprising:
acquiring content update status of said network information platform from a third electronic device, wherein said third electronic device previously stores a network platform subscription record of said second electronic device, and inquires said first electronic device for said content update status at an interval of a preset time;
according to said content update status, sending a retrieving request for the content update of said network information platform to said third electronic device;
receiving said information related to content update from said third electronic device, wherein said third electronic device, according to said content update status, previously acquires said information related to content update from said first electronic device and saves it.

10. The method of claim 1, characterized in that, before receiving said information related to content update sent by said first electronic device, further comprising:
acquiring content update status of said network information platform from a third electronic device, said third electronic device previously storing a network platform subscription record of said second electronic device and inquiring said first electronic device for said content update status at an interval of a preset time;
receiving said information related to content update from said third electronic device, wherein said third electronic device, according to said content update status, previously acquires said information related to content update from said first electronic device and saves it.

11. An electronic device for forwarding information published on the network, characterized in that, said electronic device is used to forward information related to content update published by a network information platform on a first electronic device to a second electronic device in order to display, said electronic device comprises:
a storing unit, which is used to store a network platform subscription record of said second electronic device, said network platform subscription record saving address information and/or address information of at least one network information platform to which said second electronic device previously subscribes, and said network information platform being located on said first electronic device;
a update status inquiring unit, which is used to inquire said first electronic device for content update status of said network information platform at an interval of a preset time, according to said network platform subscription record;
a update status sending unit, which is used to send said content update status to said second electronic device.

12. A method of viewing information published on the network, used in a second electronic device that is connected with at least one first electronic device via a network, characterized in that, said second electronic device comprises a displaying unit and a contact list which includes at least one contact object record, and said contact object record each includes a first part and a second part, said first part being used to record network content information that comes from a network information platform on said first electronic device, and said second part being used to record contact object information, said network information platform corresponding to said contact object record through said contact object information, said method comprising:
receiving a first operation instruction from a user of said second electronic device, and said first operation instruction being used to instruct said second electronic device to display said contact list;
based on said first operation instruction, displaying said contact list on said displaying unit;
receiving a second operation instruction from the user of said second electronic device, and said second operation instruction being used to select and open a first contact object record from said at least one contact object record;
based on said second operation instruction, selecting and opening said first contact object record;
displaying the first part and second part of said first contact object record on said displaying unit.

13. An electronic device for viewing information published on the network, connected with at least one network platform server via a network, characterized in that, said electronic device comprising:
a information receiving unit, which is used to receive information related to content update which is sent according to previous subscription of said electronic device when a network information platform on said network platform server updates content;
a storing unit, which is used to store a contact list that includes at least one contact object record, a first part of said contact object record being used to store said information related to content update, and a second part of said contact object record being used to save contact object information of said contact object record, said network information platform corresponding to said contact object record through said contact object information;
a displaying unit, which is used to display said first part and said second part in a first area and a second area respectively.

14. The electronic device of claim 13, characterized in that, said storing unit is further used to store a contact comparison table, which is used to save correspondence relationship between said network information platform and said contact object information.
